(19) United States
(12) Patent Application Publication
(10) Pub. No.: US 2015/0033668 A1
(43) Pub. Date: Feb. 5, 2015

(54) METHOD FOR LABELLING CONTAINERS AND LABELLING MACHINE

(71) Applicant: KHS GmbH, Dortmund (DE)

(72) Inventors: Klaus Krämer, Dortmund (DE); Winfried Schlüter, Hortsmar (DE); Andreas Ullrich, Neuss (DE); Lutz Deckert, Haltern am See (DE); Lutz Koertge, Hamburg (DE)

(73) Assignee: KHS GmbH, Dortmund (DE)

(21) Appl. No.: 14/379,871

(22) PCT Filed: Dec. 1, 2012
(86) PCT No.: PCT/EP2012/004969

§ 371 Date: Aug. 20, 2014

(30) Foreign Application Priority Data
Feb. 21, 2012 (DE) 10 2012 003 354.0

(51) Int. Cl. B65C 3/08

(52) U.S. Cl. CPC B65C 3/08
USPC 53/397; 53/580

(57) ABSTRACT

A method for furnishing containers with labels by transferring a label to a container that rotates about an axis thereof with a circumferential container-velocity includes using a label transfer element while the container rotates with a first circumferential container-velocity, and rolling and brushing the label onto the container as the container rotates with a second circumferential container-velocity. During brushing, the second circumferential container-velocity momentarily exceeds the first circumferential container-velocity.

### RELATED APPLICATIONS

This application is the National Stage of International Application No. PCT/EP2012/004969, filed on Dec. 1, 2012, which claims the benefit of the priority date of German Patent Application No. 10 2012 003 354.0, filed on Feb. 21, 2012. The contents of both applications are hereby incorporated by reference in their entirety.

### FIELD OF INVENTION

The invention relates to labeling containers, and in particular, to labeling rotating containers.

### BACKGROUND

Methods and associated labeling machines for labeling or furnishing containers with labels, in particular with all-round labels, are known. In known machines, a glued label is transferred to the respective container with a leading label end by a label transfer element at a transfer position. The container is moved past the label transfer position by a container transport element, for example a rotor. The label is then rolled onto the container as the container turns or rotates about its vertical or container axis. The label is then brushed on at a brushing section so that it adheres to the container tightly and without folds.

To achieve this, it is necessary among other things, for each container to be rotated or turned about its container axis during brushing through a rotary angle that corresponds at least to the length of the labels, i.e. for all-round labels that surround the container completely in the manner of a loop, through a rotary angle of at least 360°.

It is also known to use, as a label transfer element, a label transfer cylinder, preferably in the form of a vacuum cylinder, which is driven in circulation about a machine or cylinder axis. The label transfer cylinder, at its circumferential or cylinder surface, forms at least one label receiving region. Preferably, there are several label receiving regions in succession in the direction of rotation of the label transfer cylinder, each of which receives a label lying with its label front side against the label transfer cylinder and provided with a glue application on its label rear side facing away from the label transfer cylinder.

In order to achieve a proper transfer of labels to the containers in this configuration, it is necessary amongst others for the dispensing speed, which is the circumferential velocity of the label transfer cylinder, to be the same as the speed of that region of the container that is to be furnished with the label at the transfer position. This speed is the sum of the transport speed of the circulating transport element and the circumferential container-velocity of the rotational movement of the container. The circumferential container-velocity is therefore set accordingly, taking into account the transport speed of the transport element and the dispensing speed of the labeling machine or label transfer cylinder.

Previously however, the circumferential container-velocity and the transport speed of the transport element determined the length of the brushing section. This often led to brushing sections of great length. This is unfavorable for cost reasons, and in particular is a great disadvantage if, for example to increase the maximum possible output of a labeling machine on a circulating transport element, two or more labeling machines are provided, each with its associated brushing section. When this happens, the length of the transport line of the transport element that is available for labeling between a container inlet and a container outlet becomes insufficient for accommodating all labeling machines and brushing sections.

### SUMMARY

The object of the invention is to find a method for labeling containers that, while retaining a high labeling quality, allows a substantial shortening of a brushing section, in particular also when the containers are furnished with all-round labels.

As used herein, “all-round labels” means labels that, after application thereof, extend all the way around the circumference of the container.

As used herein, “containers” includes cans, bottles, tubes, pouches, each made of metal, glass and/or plastic, but also other packaging means, in particular those that are suitable for filling with liquid or viscous products.

As used herein, “substantially” includes deviations from the precise value by +/−10%, preferably by +/−5%, and/or deviations in the form of changes insignificant for function.

In one aspect, the invention features a method for furnishing containers with labels by transferring a label to a container that rotates about an axis thereof with a circumferential container-velocity includes using a label transfer element while the container rotates with a first circumferential container-velocity, and rolling and brushing the label onto the container as the container rotates with a second circumferential container-velocity. During brushing, the second circumferential container-velocity momentarily exceeds the first circumferential container-velocity.

Some practices include selecting the labels to be all-round labels.

Other practices include increasing the circumferential container-velocity during brushing. Among these are practices that include, after increasing the circumferential container-velocity, causing the container to maintain a constant circumferential container-velocity during brushing.

Also among the practices of the invention are those that include increasing the circumferential container-velocity after completely removing the label from the label transfer element, and those that include, while the label is already held on the container, and before completely removing the label from the label transfer element, increasing the circumferential container-velocity.

In yet other practices, while adhesion between the label and the container exceeds adhesion between the label and the label transfer element, and before completely removing the label from the label transfer element, the circumferential container-velocity is increased.

Alternative practices further include transferring a label to a container. Among these alternative practices are those in which transferring a label to a container comprises driving a label transfer cylinder to rotate about an axis thereof, and those in which transferring a label to a container comprises driving comprises driving a vacuum cylinder about an axis thereof.

In another aspect, the invention features an apparatus for furnishing containers with labels. Such an apparatus includes a labeling machine, a transport element that is driven in circulation, container positions on the transport element, a circulation track of the container positions, a first labeling assembly that does not circulate with the transport element, and that is on the circulation track, a first brushing section disposed downstream of the label transfer element in a transport direction of the transport element and formed in part by a brushing channel, a label transfer element, and a drive system. The containers, each of which is arranged at a respective container position, are moved by the circulating transport element past the label transfer element. Upon arriving at the label transfer element, a container receives a transfer of a label from the label transfer element. The drive system rotates a container about a corresponding container axis thereof. In the course of either winding or wrapping the label onto the container, the drive system rotates the container with a circumferential container-velocity. In the first brushing section, the drive system further rotates the container for brushing the label onto the container, and increases the circumferential container-velocity after transfer of a label to a respective container.

Embodiments include those in which the transport element comprises a rotor that can be driven in circulation about a vertical machine axis.

Also included are embodiments in which the labeling machine is configured to accommodate all-round labels.

In some embodiments, the drive system comprises a plurality of drives, each of which is associated with a container position. Each of the drives is separately and individually controllable for controlling a container carrier formed at the container position.

Further embodiments include those in which the drive is configured such that the circumferential container-velocity is increased at a container position before the container position reaches the first brushing section, and those in which the drive is configured such that the circumferential container-velocity is increased at a respective container position while the container position concerned lies within the first brushing section.

Yet other embodiments include those in which the drive is configured such that the circumferential container-velocity is increased after the label has been completely removed from the label transfer element, and those in which the drive is configured such that the circumferential container-velocity is increased while the label is still partly held on the label transfer element.

Also among the embodiments are those that include g a second labeling assembly, and a second brushing section associated with the second labeling assembly. The first labeling assembly and the second labeling assembly are provided in succession in the transport direction of the transport element on the circulation track.

The invention is explained in more detail below with reference to the figures, which show exemplary embodiments.

### BRIEF DESCRIPTION OF THE DRAWINGS

Refinements, advantages and possible applications of the invention arise from the description below of exemplary embodiments and from the figures. All features described and/or shown in the figures, alone or in any combination, are in principle the object of the invention, irrespective of their summary in the claims or back reference. The content of the claims is also declared a constituent part of the description.

In the drawings,

FIG. 1 shows, diagrammatically and in top view, a labeling machine of the circulating type for labeling containers in the form of bottles;

FIG. 2 shows, in side view, a bottle furnished with an all-round label;

FIG. 3 shows the development of the circumferential container-velocity of the rotation movement of the container during transfer of the label and during subsequent rolling and brushing of the label onto the container;

FIG. 4 shows the rotary angle of the respective container on transfer of the label and on subsequent rolling and brushing, in relation to the rotary angle of the rotor of the labeling machine serving as a container transport element, in the configuration according to the invention and in the prior art; and

FIG. 5 shows a further embodiment of the invention.

### DETAILED DESCRIPTION

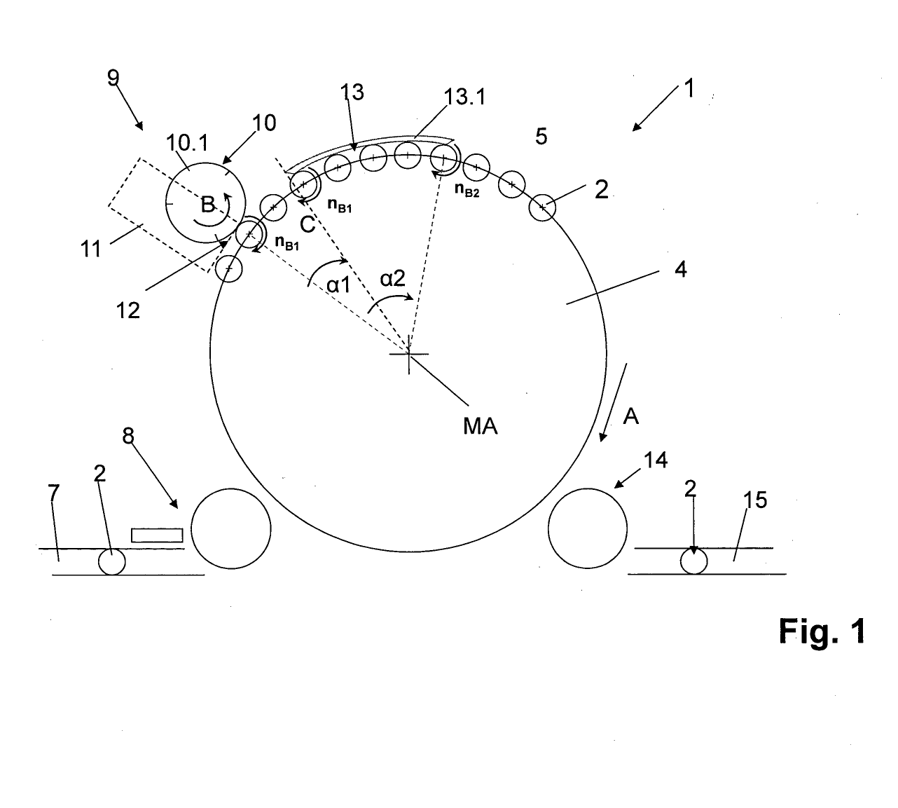

A first labeling machine 1 of circulating type, shown in FIG. 1, labels or furnishes containers 2, such as bottles, with all-round labels 3. These all-round labels completely surround the respective container 2 at a container region, for example, formed rotationally symmetrical in relation to a vertical or container axis BA, are connected by overlapping their label ends or short sides 3.1 and 3.2, and surround the container axis BA with the label long sides 3.3 in the manner of a ring.

The labeling machine comprises, amongst others, a circulating rotor 4 that is driven in circulation about a vertical machine axis MA in rotor direction of rotation A. On the periphery of the rotor 4, distributed at even angular distances about the machine axis MA, are formed container positions 5. Each container position 5 has a container receiver 6, which in the embodiment shown is formed by a turntable or container plate and can be rotated about a vertical axis under control by a drive 6.1. In some embodiments, the drive 6.1 is an electric motor drive controlled by rotation speed that is provided individually controllable for each container position 5.

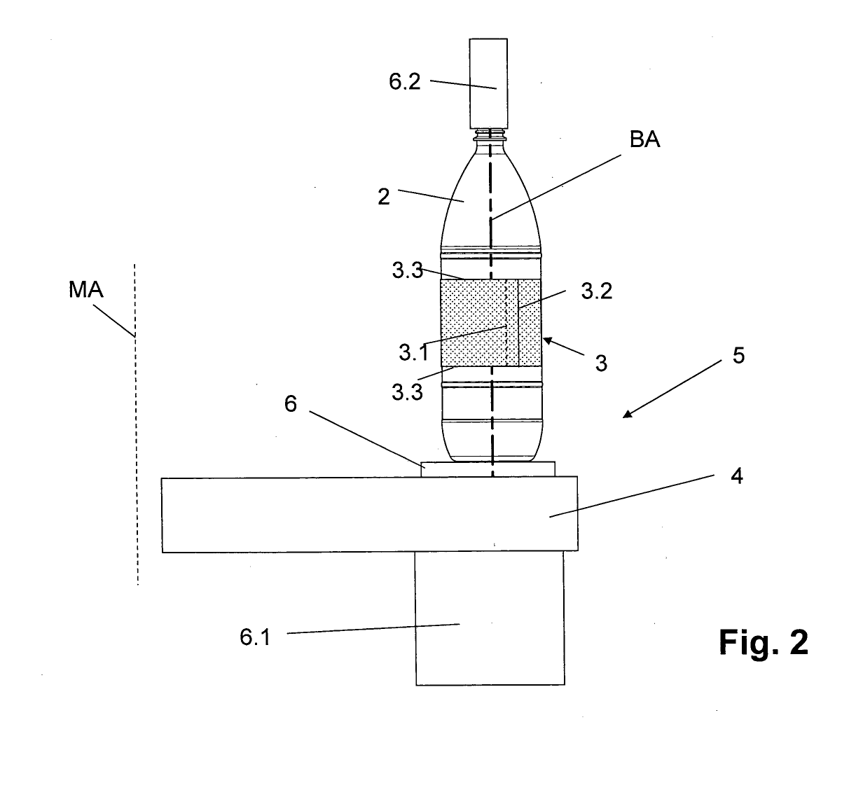

The containers 2 to be labeled are transferred by an outer transporter 7 and a container inlet 8, depicted diagrammatically as a transport star with an upstream divider worm, to a container position 5 at which the containers 2 are arranged standing with their container base on the container receiver 6 and secured by an upper die 6.2, best seen in FIG. 2. Each container 2 is moved with the circulating rotor 4 past a labeling machine 9 that does not circulate with the rotor 4, of which in the diagram only a label transfer cylinder 10, preferably in the form of a vacuum cylinder, and an apparatus 11 for presenting the labels 3, for example a label box, are shown.

The label transfer cylinder 10 is driven in synchrony with the rotor 3 about a vertical cylinder axis but in the opposite direction to the rotation direction of the rotor 4, as indicated by arrow B, which indicates the label transfer cylinder's direction of rotation). On its circular cylindrical periphery, the label transfer cylinder 10 has at least one, preferably more, label receiving regions 10.1 in succession in the direction of rotation B, which each receive a label 3 that is held by its label front side on the label transfer cylinder 10 and is provided with an application of glue on its label rear side facing away from the label transfer cylinder 10, such that its label short side 1.3 leads the label receiving region 10.1 in relation to the direction of rotation B, its label short side 3.2 trails, and its two label long sides 3.3 are arranged in the direction of rotation B.

Whenever a container 3 reaches the label transfer cylinder 10 or label transfer position 12 located thereon, a label 3 with its glued label short side 3.1 is transferred to or pressed onto the arriving container 2. Then, under rotation of the container 2 about its vertical container axis BA, the label 3 is rolled onto the container 2 in a direction of rotation C opposite the direction of rotation B, so that finally it surrounds the container 2 with the trailing label short side 3.2 overlapping the label short side 3.1.

During the rolling step, the container 2, which is carried with the circulating rotor 4, reaches a brushing section or enters a brushing channel 13 that presses or brushes the label 3 onto the container 2 so that it lies on or surrounds the container 2 tightly and without folds. The brushing channel 13, which can be seen in FIG. 1, is formed by a brush arrangement 13.1, that also does not circulate with the rotor 4, and that surrounds the rotor 4 in the manner of an arc. As the brushes in the brushing channel 13 brush the label 3 on, the containers 2 continue to rotate about their container axes BA in the direction of rotation C.

Upon being furnished with labels 3, the containers 2 are extracted from the container positions 5 at a container outlet 14 and passed on to an external transporter 15.

To allow the labeling of the containers 2, several conditions must be fulfilled.

First it is necessary to synchronize the label transfer cylinder 10 with the rotor 4 such that whenever the rotor 4 moves a container 2 to the transfer position 12, a label receiving region 10.1 is present there for transferring the label 3 with its label short side 3.1.

Second, it is necessary for the circumferential cylinder-velocity of the label transfer cylinder 10 presenting the respective label 3, and the velocity of the region of the container 2 receiving the label 3, to be the same in magnitude and direction on transfer of the label, i.e. at the transfer position 12. The circumferential cylinder-velocity of the label transfer cylinder 10 corresponds to the dispensing speed, which substantially results from the length of the labels 3, and in particular, from the spacing between the label short sides 3.1, 3.2, and the number of labels transferred to containers 2 per unit of time. The velocity of the region of the container 2 receiving the label 3 on label transfer is the sum of a circumferential rotor-velocity nR, i.e. the velocity of the rotor 4 as it rotates about its axis, and a first value nB1 of the circumferential container-velocity nB, which is the velocity at which the containers 2 rotate about their container axis BA in direction of rotation C on transfer of the labels. The circumferential rotor-velocity nR results from the spacing (e.g., the pitch spacing in millimeters) between two successive containers 2 or container positions 5 in the rotor direction of rotation A, and the number of containers 2 labeled per unit of time.

The first value nB1 of the circumferential container-velocity nB on label transfer is therefore the difference between the dispensing speed of the label transfer cylinder 10 and the circumferential rotor-velocity nR, which is usually lower than the dispensing speed but never greater than the dispensing speed. To achieve these conditions, the circumferential container-velocity nB on label transfer can correspond to non-negative values, i.e. nB1≧0. In each case however the direction of rotation C of the containers 2 is the same as the rotor's direction of rotation A, so that the circumferential container velocities nB and the circumferential rotor-velocity nR add.

To achieve a tight and fold-free contact of the labels 3 on the containers 2, it is necessary that, during its passage through the brushing channel 13, each container is turned about its container axis BA through a sufficient rotary angle, preferably a rotary angle of at least 360°. To achieve this, the brushing channel 13 needs to have a sufficient length. This length depends on the circumferential rotor-velocity nR and the circumferential container-velocity nB of the containers 2 rotating about their respective container axes BA.

FIG. 1 shows a first angular region α1 and a second angular region α2. The first angular region al is the angular region of the rotary movement of the rotor 4 between the transfer position 12 and the start of the brushing channel 13. The second angular region α2 is the angular region of the rotary movement of the rotor 4 between the transfer position 12 and the end of the brushing channel 13.

To keep the length of the brushing channel 13 as short as possible, the first labeling machine 1 presented according to the invention is formed such that, by corresponding control of the drives 6.1, the circumferential container-velocity nB is increased from the first value nB1 to a second value nB2. In the embodiment shown, this occurs when the respective container 2 is inside the brushing channel 13, i.e. after it has left the first angular region α1.

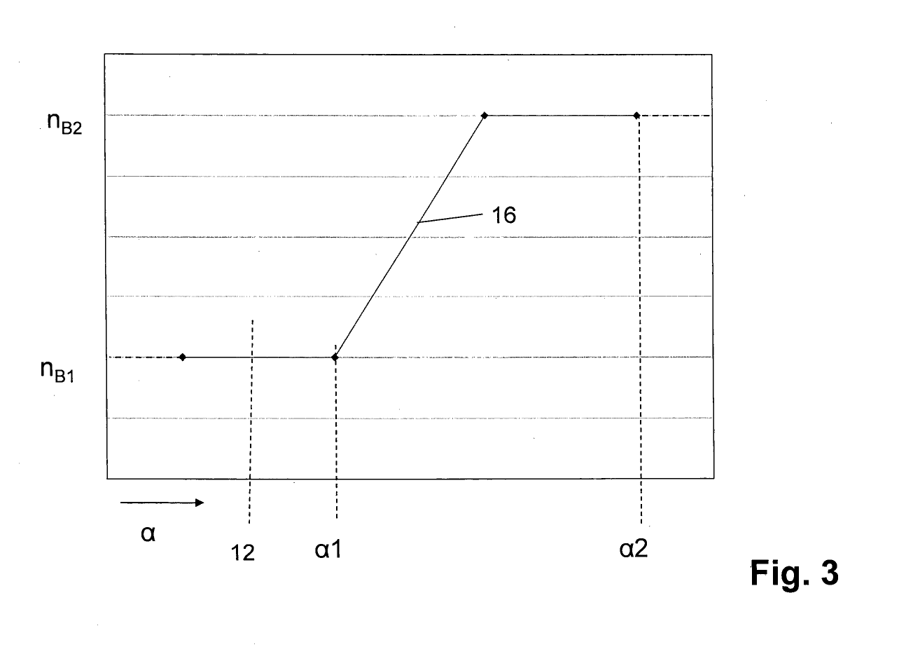

In FIG. 3, a velocity curve 16 shows the evolution of the circumferential container-velocity nB as a function of location before and after passing the transfer position 12. Initially, the circumferential container-velocity nB is constant or substantially constant and corresponds to the first value nB1. After the container 2 enters the brushing channel 13, i.e. after leaving the first angular region α1, the circumferential container-velocity nB increases to the second value nB2 and remains constant over the majority of the length of the brushing channel 13, at least until the end of the second angular region α2.

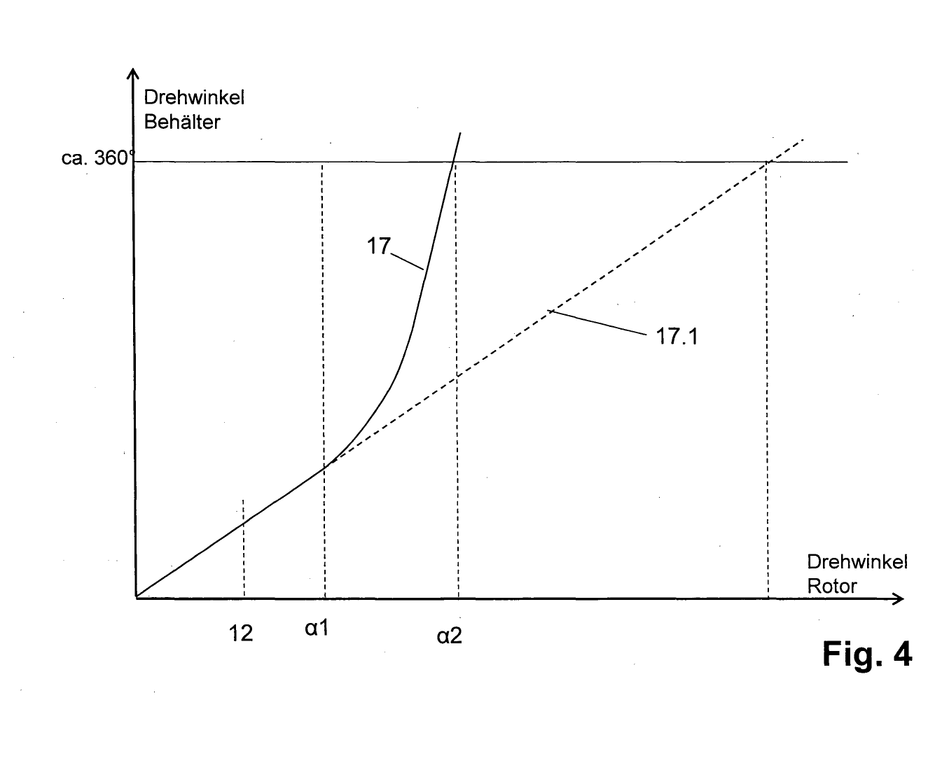

In FIG. 4, an angle curve 17 shows the rotary angle of the container 2 as a function of the rotary angle of the rotor 4. Before and after the label transfer, there is a preferably linear increase in the rotary angle of the container 2 about its container axis BA in relation to the rotary angle of the rotor 4. This corresponds to the constant first value nB1. Then, after leaving the first angular region α1, the rotary angle of the container 2 rises disproportionately in relation to the rotary angle of the rotor 4. This corresponds to the increase in circumferential container-velocity nB from the first value nB1 to the second value nB2. Then the respective container 2 rotates with the increased circumferential container-velocity at the second value nB2, so that the curve 17 again becomes linear, but with steeper slope. At a rotary angle of 360°, the container 2 reaches the end of the second angular region α2, which is also the end of the brushing section 13.

The circumferential container-velocity nB is increased, for example, when the respective label 3 has been fully rolled on the container 2. It can also be increased before the respective label 3 has been fully rolled onto the container 2, but is already held sufficiently firmly on the container 2. In this context, “sufficiently firmly” means that the retaining force between the label 3 and the container 2 is greater than the retaining force between the label 3 and the label transfer cylinder 10. This condition is achieved, for example, when the label 3 is held on the container 2 by at least around 30% of its total length. The label 3 is then pulled off the label transfer cylinder 10 under friction.

The dotted curve 17.1 in FIG. 4 shows the rotary angle of the container 2 as a function of the rotary angle of the rotor 4 when there is no increase in circumferential container-velocity nB of the containers. A comparison of curves 17 and 17.1 shows that in the configuration according to the invention, there is a substantial shortening of the necessary length of the brushing channel 13.

This advantage of the invention applies in particular when, for example to increase the maximum possible output of the labeling machine, several labeling assemblies 9 are arranged on a common rotor 4 in succession in the direction in which the rotor rotates A, and each has a brushing channel 13 directly following the labeling machine in the rotor's direction of rotation A, and these labeling assemblies 9 are controlled such that the labeling assemblies 9 label the containers 2 alternately.

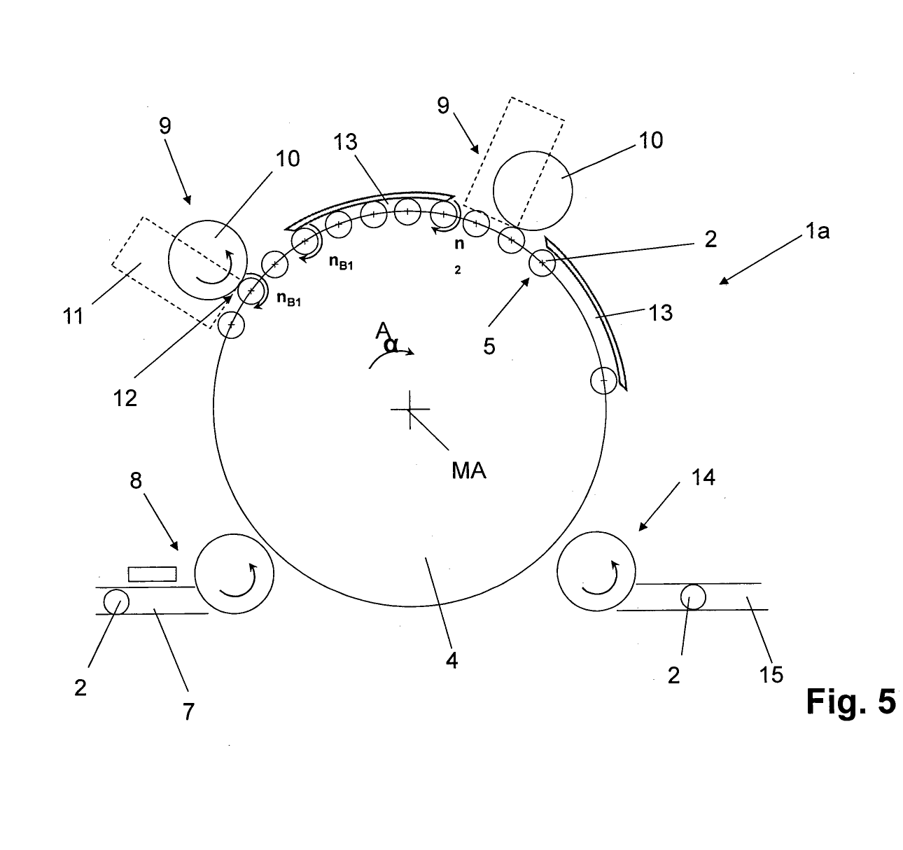

A second labeling machine 1a with two such labeling assemblies 9 is shown in FIG. 5. Apart from the additional labeling assembly 9, this second labeling machine 1a corresponds in structure to the first labeling machine 1 and therefore the same reference numerals are used in FIG. 5 as in FIG. 1.

The first labeling assembly 9 in relation to the rotor direction of rotation A labels every second container 2 moving past on the rotor 4. The second labeling assembly 9, which follows the brushing channel 13 of the first labeling assembly 9 in the rotor direction of rotation A, labels those containers 2 that do not yet have a label 3. A second brushing channel 13 follows the second labeling assembly 9 in the rotor direction of rotation A.

If the second labeling machine 1a is operated at the same output as the first labeling machine 1 with just a single labeling assembly 9, the number of labels 3 to be transferred by each labeling assembly 9 is halved and hence the circumferential cylinder-velocity of the label transfer cylinder 10 or the dispensing speed is also halved. As a result there is a corresponding reduction in circumferential container-velocity nB at label transfer that, without an increase in circumferential container-velocity nB from the first value nB1 to the second value nB2, would necessarily require a lengthening of the brushing channel 13 in order to ensure a rotation of each container 2 by the necessary 360° inside the respective brushing channel. In the extreme case this can lead to the circumferential or angular region of rotational movement of the rotor 4 available for treatment of the containers 2 between the container inlet 8 and container outlet 14 not being sufficient to accommodate the labeling assemblies 9 and the brushing channels 13 with the necessary length, or the diameter of the rotor 4 having to be enlarged accordingly, which in practice however is undesirable for cost reasons.

The second labeling machine la is also designed such that, after transfer and adequate fixing of the respective label 3 onto a container 2, the circumferential container-velocity nB is increased from the first value nB1 to the second value nB2 inside the respective brushing channel 13 so that its length can be greatly reduced. As a result, there is room for two or even more than two labeling assemblies 9 with associated brushing channels 13 at the periphery of the rotor 4 between the container inlet 8 and the container outlet 14.

The invention has been described above with reference to exemplary embodiments. It is evident that numerous modifications and derivations are possible without leaving the inventive concept on which the invention is based.

It has been assumed above that the circumferential container-velocity nB is increased inside the brushing channel 13. The increase in velocity can also be initiated before the container 2 has reached the brushing channel 13.

It has also been assumed above that the container carrier 6 is formed as a turntable. However, other forms of container carrier 6 are possible, such as container carriers for suspended fixing of the containers.

It has also been assumed that a separate electric motor drive 6.1 is associated with each container carrier 6. However, other drives that allow a change in circumferential container-velocity of the rotating containers 2 can be used.

In the description above and in the exemplary embodiments it has also been assumed that the labels are exclusively all-round labels. However, the method and the labeling machine described herein are also suitable for processing all other known label types, so that the scope of protection of the present invention also extends to such applications. Non-limiting examples of labels that can be used with the labeling machine include self-adhesive labels, cold-glue labels and hot-glue labels.

It has also been assumed above that the labels are always transported with their short side leading. However, this is not mandatory. Within the context of the present invention the phrase “label short side” should, in case of doubt, also be understood to mean the side of the label that leads the label on transport of the label in the transport direction.

1-10. (canceled)

11. A method for furnishing containers with labels by transferring a label to a container that rotates about an axis thereof with a circumferential container-velocity, said method comprising using a label transfer element while said container rotates with a first circumferential container-velocity, and rolling and brushing said label onto said container as said container rotates with a second circumferential container-velocity, said method further comprising, during brushing, causing said second circumferential container-velocity to at least momentarily exceed said first circumferential container-velocity.

12. The method of claim 11, further comprising selecting said labels to be all-round labels.

13. The method of claim 11, further comprising increasing said circumferential container-velocity during brushing.

14. The method of claim 13, further comprising, after increasing said circumferential container-velocity, causing said container to maintain a constant circumferential container-velocity during brushing.

15. The method of claim 11, further comprising increasing said circumferential container-velocity after completely removing said label from said label transfer element.

16. The method of claim 11, further comprising, while said label is already held on said container, and before completely removing said label from said label transfer element, increasing said circumferential container-velocity.

17. The method of claim 11, further comprising, while adhesion between said label and said container exceeds adhesion between said label and said label transfer element, and before completely removing said label from said label transfer element, increasing said circumferential container-velocity.

18. The method of claim 11, further comprising transferring a label to a container.

19. The method of claim 18, wherein transferring a label to a container comprises driving a label transfer cylinder to rotate about an axis thereof.

20. The method of claim 18, wherein transferring a label to a container comprises driving comprises driving a vacuum cylinder about an axis thereof.

21. An apparatus for furnishing containers with labels, said apparatus comprising a labeling machine, a transport element, container positions, a circulation track, a first labeling assembly, a first brushing section, a brushing channel, a label transfer element, and a drive system, wherein said first labeling assembly does not circulate with said transport element, wherein said circulation track comprises a circulation track of said container positions, wherein said container positions are on said transport element, wherein said transport element comprises a transport element that is driven in circulation, wherein said first labeling assembly is provided on said circulation track, wherein said first brushing section is disposed downstream of said label transfer element in a transport direction of said transport element, wherein said brushing channel is a constituent of said first brushing section, wherein said containers, each of which is arranged at a respective container position, are moved by said circulating transport element past said label transfer element, wherein, upon arriving at said label transfer element, a container receives a transfer of a label from said label transfer element, wherein said drive system rotates a container about a corresponding container axis thereof, wherein, in the course of at least one f winding and wrapping said label onto said container, said drive system rotates said container with a circumferential container-velocity, wherein, in said first brushing section, said drive system further rotates said container for brushing said label onto said container, and wherein said drive system is configured to increase said circumferential container-velocity after transfer of a label to a respective container.

22. The apparatus of claim 21, wherein said transport element comprises a rotor that can be driven in circulation about a vertical machine axis.

23. The apparatus of claim 21, wherein said labeling machine is configured to accommodate all-round labels.

24. The apparatus of claim 21, wherein said drive system comprises a plurality of drives, each of which is associated with a container position, wherein each of said drives is separately and individually controllable for controlling a container carrier formed at said container position.

25. The apparatus of claim 21, wherein said drive is configured such that said circumferential container-velocity is increased at a container position before said container position reaches said first brushing section.

26. The apparatus of claim 21, wherein said drive is configured such that said circumferential container-velocity is increased at a respective container position while said container position concerned lies within said first brushing section.

27. The apparatus of claim 21, wherein said drive is configured such that said circumferential container-velocity is increased after said label has been completely removed from said label transfer element.

28. The apparatus of claim 21, wherein said drive is configured such that said circumferential container-velocity is increased while said label is still partly held on said label transfer element.

29. The apparatus of claim 21, further comprising a second labeling assembly, and a second brushing section associated with said second labeling assembly, wherein said first labeling assembly and said second labeling assembly are provided in succession in said transport direction of said transport element on said circulation track.
